(19) United States
(12) Patent Application Publication
(10) Pub. No.: US 2003/0171961 A1
(43) Pub. Date: Sep. 11, 2003

(54) System and method for dynamically routing an object through an organization's workflow system

(75) Inventors: Tejaswini Hosali, Durham, NC (US); William John Reilly, Cary, NC (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/091,827

(22) Filed: Mar. 6, 2002

(51) Int. Cl. G06F 17/60

(52) U.S. Cl. 705/7

(57) ABSTRACT

A system and associated method dynamically route an object through an organization's workflow system by using, for example, the Systems Applications and Products (SAP) workflow technology so that whenever changes are made to an organization, they are automatically reflected in the workflow. The workflow routes do not need to be updated every time a change is made to either an organization database or a customer database, increasing the efficiency of the organization's productivity by implementing a single routing structure for all processes, across all applications, throughout the organization, worldwide. The ability to have an open, flexible routing method that reaches a low level of granularity within an organization improves productivity by sending the work items to specific recipients, and further improves the system and network performance by selectively sending only work items to these specific recipients as opposed to large groups of people.

### FIELD OF THE INVENTION

The present invention relates in general to data management systems. More particularly, this invention relates to a system and associated method for dynamically routing an object through an organization's workflow system.

### BACKGROUND OF THE INVENTION

A Systems Applications and Products (SAP) workflow provides the infrastructure and tools that enable business processes and human resources management more efficiently. It routes data quickly to the proper individual, even if the person is in a different office or country, and facilitates the administrators' task of dealing with transactions and forwarding them through the chain of command.

The SAP workflow enables business processes to be defined according to organizational standards and organization-specific procedures. The workflow may be monitored and information on the current status of a task or work item may be viewed at any time. Work load distribution and identifying capacity problems or work overload can be identified before developing into a problem. With the SAP workflow, administrators can approve transactions, even partially, in a uniform process.

It would be desirable to have a system and method that improve the performance of SAP workflows, and that cause changes made to the organization to be automatically reflected in the workflow by efficiently routing the corresponding object through the organization's workflow system.

### SUMMARY OF THE INVENTION

The present invention meets the need for the routing requirement of an object through an organization's workflow system. To this end, the system and associated method of this invention can utilize, for example, the Systems Applications and Products (SAP) workflow technology so that whenever changes are made to an organization, they are automatically reflected in the workflow. Since the SAP workflow is position-based, rather than person-based, the workflow routes do not need to be updated every time an employee is promoted or changes jobs, thus increasing the efficiency of the organization's sales, purchasing, and human resources, by implementing a single routing structure for all processes, across all applications, throughout the organization, worldwide. The ability to have an open, flexible routing method that reaches a low level of granularity within an organization or organizations improves productivity by sending the work items to specific recipients, and further improves the system and network performance by selectively sending only work items to those specific recipients as opposed to large groups of people.

The present system and method for routing an object through an organization's workflow system can be implemented by:

A. Parsing the object into portions likely to follow different workflow paths. An example is to read an inbound Sales Order IDoc (i.e., files that are sent from an external customer using a format such as Electronic Data Interchange (EDI), formatted for the system to read) information. In this example, the system pulls the Customer number from which it will pull additional information as stated below.

B. Examining information contained in each portion, external information related to each portion, an organizational structure, and a set of business rules for the organization. In the example above, this step includes finding the Account Administrator contact number of the customer (for the country for which the Sales Order is related), determining the relationship/value for that contact number, and determining which Organizations and Jobs/Positions are related. If the Account Administration contact number is not found in the customer master data base, then the country of the customer is utilized. If there is no Organization or Position for that country, the work item is routed to the predefined possible job (or jobs).

C. Based on the examination step above, determining a destination for the object that is at the most granular level within the organization that complies with the business rules. Using the information gathered in the above example, the system finds the related Organization and/or Position using the most granular level. The Organization, Position and/or Job are then used to find the most appropriate user(s) for that work item. The specific person and/or group that needs the information (e.g., the Account Administrator contacts for large countries where this needs to be defined at the granular level), the Country Account Administrators for smaller, less business active countries, and/or the predefined jobs for the work item. This search for the most granular level is logic which is defined for many different work items for the World Wide organizations (e.g., New Order work items, customer Sales Order changes, Contract information changes requiring specific user intervention, transaction error handling, important customer data information changes, customers placed on the Denied Parties List, etc.).

The present system and associated method of the present invention present numerous advantages among which are the following:

They offer an open and flexible design that can be used for multiple workflow routings.

They identify the routing with specificity, therefore improving the system performance, which would otherwise be adversely affected when, for example a give notification is sent to numerous, non-concerned recipients.

They provide for worldwide support of large diverse group separation, thus increasing the efficiency and productivity of the entire organization.

They allow the organization's branch offices in various countries to determine the ‘grouping’ of any function, such as by branch office, individuals, geographic area, etc. Therefore, allowing autonomous control worldwide.

They allow immediate, real-time resolution for customer related transactions such as Sales Order resolution, for recognizing revenue.

They aim at higher customer satisfaction due to a real-time notification of appropriate support person(s).

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system and method for dynamically routing an object may be used according to the present invention; and

FIG. 2 is a flowchart illustrating the operation of the system of FIG. 1.

### DETAILED DESCRIPTION OF PREFERRED EMBODIMENTS

The following definitions and explanations provide background information pertaining to the technical field of the present invention, and are intended to facilitate the understanding of the present invention without limiting its scope:

IDoc: Acronym for intermediate document, and refers to a file sent from an external customer using a format such as Electronic Data Interchange (EDI), for a system to read.

Internet: A collection of interconnected public and private computer networks that are linked together with routers by a set of standards protocols to form a global, distributed network.

Local Area Network: A communications network that serves users within a confined geographical area. It is made up of servers, workstations, a network operating system and a communications link.

Parse: To divide a text into small components that can be analyzed. Parsing is often divided into lexical analysis and semantic parsing. Lexical analysis concentrates on dividing strings into components, called tokens, based on punctuation and other keys. Semantic parsing then attempts to determine the meaning of the string.

Pointer: Refers to the relationship to a set of data. Pointers can be used to reference specific sets of data while also allowing arguments to be passed.

Workflow path: A route to the most specific person and/or group in an organization.

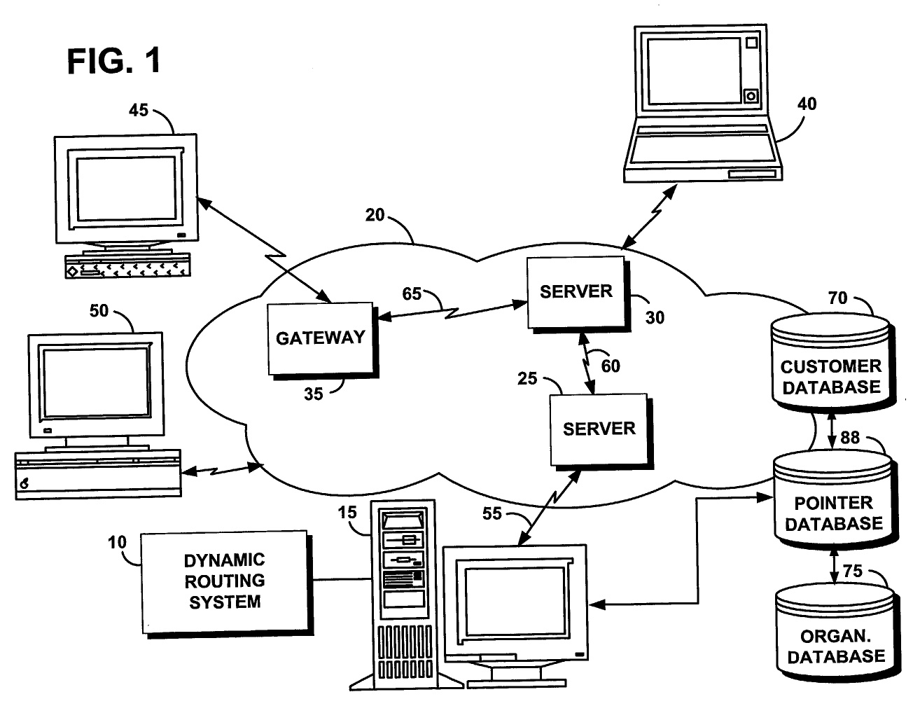

FIG. 1 portrays an exemplary environment in which a system 10 and method for dynamically routing an object according to the present invention may be used. The dynamic routing system 10 includes a software or computer program product that is typically embedded within or installed on a host server 15. Alternatively, the system 10 can be saved on a removable storage medium such as a diskette, a CD, or hard drive, or like devices.

The cloud-like communication network 20 is comprised of communication lines and switches connecting servers such as servers 25, 30 to gateways such as gateway 35. The servers 25, 30 and the gateway 35 provide the communication access to the Internet. Users, such as managers, employees, clients, or other remote Internet users are represented by a variety of computers such as computers 40, 45, 50. The host server 15 is connected to the network 20 via a communications link 55 such as a telephone, cable, or satellite link. The servers 25, 30 can be connected via high speed Internet network lines 60, 65 to other computers and gateways.

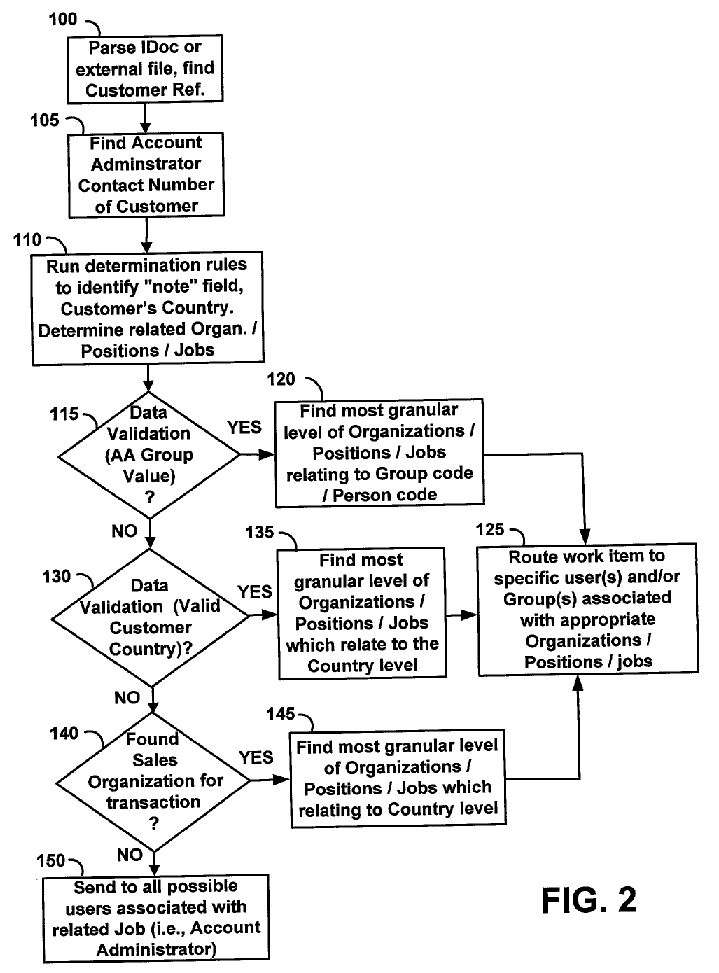

The operation of the dynamic routing system 10 can be illustrated by the routing of relevant information through the organization workflow, as illustrated in the flowchart of FIG. 2. The system 10, operating in conjunction with an e-mail routing system, receives an electronic document via the Internet, local area network, or any other appropriate electronic transmission.

The dynamic routing system 10 accesses information contained in a customer database 70 and an organization database 75. In operation, a work item (or notification) is sent from the client, as represented by the computer, for example, by the computer 40, to the dynamic routing system 10 through the Internet or local area network 20.

A pointer database 88 contains a plurality of pointers that link the customer to the organization, and are determined by, for example, the account administrator's group code, the client's country of residence, and the sales organization. Other criteria could be also used to define the pointers, as required. In the present example, these alternative pointers can be an organizational text field link that relates to a partner function link on the customer records (or objects). In addition, this example assumes that the first priority for routing is the account administrator or account administrator group, the client's ship-to country, and then the sales organization.

FIG. 2 illustrates a method of operation 100 of the dynamic routing system 10 of FIG. 1. Method 100 analyzes an incoming document, at step 102, parsing the text in the IDoc or other external files to determine the customer reference number. Method 100 then uses the customer reference number to locate the client in the customer database 70. From the client's record in the customer database 70, method 100 retrieves the account administrator contact number for the customer, at step 105.

At step 110, method 100 performs determination rules to identify the “note” field on the contact record and the customer's country of residence. Using this information, method 100 determines the sales organizations, employee positions and jobs related to the customer/client record.

System 10 first checks the identity of the account administrator (AA) at step 115. If an account administrator group is located in the contact record(s) of the customer/client, system 10 proceeds to step 120. System 10 then searches the organization database 75 for the most granular level (e.g., the specific Account Administrator individual) of the positions, jobs, or organizational units that relate to the group code or person code indicated by that account administrator identification. System 10 then routes the work item at step 125 to specific users and/or groups, as determined from the organization database 75.

If no account administrator group, and/or contact record, is located at step 115, system 10 proceeds to step 130 and checks for the identity of the client's country of residence. If such a country is located, system 10 continues to step 135. System 10 then searches the organization database 75 for the most granular level of the positions, jobs, or organizational units that relate to the group code or person code indicated by that country. System 10 then routes the work item, at step 125, to specific users and/or groups as determined from the organization database 75.

If no country of residence is found for the client at step 130, system 10 continues to step 140 and determines the sales organization for the transaction represented by the IDoc. If the sales organization is located, system 10 proceeds to step 145. System 10 then searches the organization database 75 for the most granular level of the positions, or jobs, or organizational units that relate to the group code or person code indicated by that sales organization.

System 10 then routes the work item at step 125 to specific users and/or groups as determined from the organization database 75. For a work item with no account administrator group, country, or sales organization, the work item is routed at step 150 to all possible users associated with the related job.

As seen in this example, the routing using the two databases is dynamic, with pointers utilized as needed from the customer database 70 to the organization database 75. The routing of objects utilizing the customer data and the organization data can change from document to document, depending on the information received and available to the system 10. The routing is determined by the application and is created on an as-needed basis.

It is to be understood that the specific embodiments of the invention that have been described are merely illustrative of certain application of the principle of the present invention. Numerous modifications may be made to the system and method of dynamically routing an object through an organization's workflow system described herein without departing from the spirit and scope of the present invention. Moreover, while the present invention is described for illustration purpose only in relation to Internet communications, it should also be clear that the invention is applicable as well to documents and files shared electronically over any type of electronic or wireless network.

What is claimed is:

1. A method of routing an object through a workflow system, comprising:
parsing the object into portions that are likely to follow different workflow paths;
examining information and an organizational structure contained in each parsed portion; and
based on examined information and organizational structure, determining an appropriate destination for the object at a lowest possible granularity level within the organizational structure.

2. The method of claim 1, further including examining external information, if any, related to each parsed portion, to further determine the lowest possible granularity level of the object destination.

3. The method of claim 2, further including examining a set of business rules, if any, contained in each parsed portion and related to the organizational structure, to further determine the lowest possible granularity level of the object destination.

4. The method of claim 3, wherein parsing the object into portions includes parsing the object into subsets of information.

5. The method of claim 3, wherein the subsets of information include customer information.

6. The method of claim 3, wherein the subsets of information include customer credit information

7. The method of claim 3, wherein the subsets of information include country information.

8. The method of claim 3, wherein the object includes an intermediate document.

9. The method of claim 3, wherein the object includes a transactional document.

10. The method of claim 3, wherein the organization structure includes an organizational hierarchy.

11. The method of claim 3, wherein the set of business rules includes specific routing rules.

12. A computer program for routing an object through a workflow system, comprising:
a first set of instructions for parsing the object into portions that are likely to follow different workflow paths;
a second set of instructions for examining information and an organizational structure contained in each parsed portion; and
a third set of instructions for determining an appropriate destination for the object at a lowest possible granularity level within the organizational structure, based on examined information and organizational structure.

13. The method of claim 12, wherein the second set of instructions includes instructions for examining external information related to each parsed portion, to further determine the highest granularity level of the object destination.

14. The method of claim 13, wherein the second set of instructions includes instructions for examining a set of business rules against each parsed portion and related to the organizational structure, to further determine the highest granularity level of the object destination.

15. The method of claim 14, wherein the first set of instructions includes instructions for parsing the object into subsets of information.

16. The method of claim 14, wherein the subsets of information include customer information.

17. The method of claim 14, wherein the subsets of information include customer credit information

18. The method of claim 14, wherein the subsets of information include country information.

19. The method of claim 14, wherein the object includes an intermediate document.

20. The method of claim 14, wherein the object includes a transactional document.

21. The method of claim 14, wherein the organization structure includes an organizational hierarchy.

22. The method of claim 14, wherein the set of business rules includes specific routing rules.

23. A system for routing an object through a workflow system, comprising:
means for parsing the object into portions that are likely to follow different workflow paths;
means for examining information and an organizational structure contained in each parsed portion; and
means for determining an appropriate destination for the object at a lowest possible granularity level within the organizational structure, based on the information and the organizational structure.

24. The system of claim 23, wherein the examining means includes instructions for examining external information and a set of business rules related to each parsed portion, to further determine the lowest possible granularity level of the object destination.
